(19) United States
(12) Patent Application Publication
(10) Pub. No.: US 2017/0201723 A1
(43) Pub. Date: Jul. 13, 2017

(54) METHOD OF PROVIDING OBJECT IMAGE BASED ON OBJECT TRACKING

(71) Applicant: ELECTRONICS AND TELECOMMUNICATIONS RESEARCH INSTITUTE, Daejeon (KR)

(72) Inventors: Yookyung Kim, Daejeon (KR); Kwang-Yong Kim, Daejeon (KR); Gi Mun Um, Daejeon (KR); ALEX LEE, Daejeon (KR); Kee Seong Cho, Daejeon (KR); Gyeong-June Hahm, Daejeon (KR)

(21) Appl. No.: 15/397,844

(22) Filed: Jan. 4, 2017

(30) Foreign Application Priority Data
Jan. 7, 2016 (KR) 10-2016-0001872

(51) Int. Cl. H04N 7/18; G06F 3/0484; H04N 5/232

(52) U.S. Cl. CPC H04N 7/181; H04N 5/23296; G06F 3/04842

(57) ABSTRACT

A method of providing an object image includes collecting a global image and an additional image of a predetermined space using a fixed camera and a tracking camera, displaying broadcast contents including the collected global image and additional image on a display, receiving an input of an object of interest selected by a user from the broadcast contents displayed on the display, and analyzing the object of interest selected from the broadcast contents and displaying the additional image mapped to the global image configuring the broadcast contents on the display.

### CROSS-REFERENCE TO RELATED APPLICATION(S)

This application claims the priority benefit of Korean Patent Application No. 10-2016-0001872, filed Jan. 7, 2016, in the Korean Intellectual Property Office, the disclosure of which is incorporated herein by reference for all purposes.

### BACKGROUND

1. Field

One or more example embodiments relate to a method of providing an object image based on an object tracking and, more particularly, to a method of providing an additional image of an object of interest within an image provided through a broadcasting service.

2. Description of Related Art

In general object tracking technology, an object tracking may be performed by acquiring an image using a fixed camera or a moving camera capturing a predetermined space and analyzing a position of an object in the acquired image. The object tracking technology has been earnestly studied in a computer vision academic community, and may be applied to, for example, a security service based on an indoor and outdoor closed-circuit television (CCTV) and a service for analyzing a sport game.

In terms of a recent launched object tracking system, two fixed cameras may be positioned on a ceiling of a stadium to detect a player while an indoor sport game is being played in the stadium. Also, the system may verify common information on a team of the detected player and acquire images by tracking positions of players in real time. In this example, the fixed camera may be used to collect a global image with a relatively low resolution. To acquire information on an object with increased accuracy, the moving camera may operate in conjunction with the fixed camera. A representative type of the moving camera may be, for example, a pan-tilt-zoom (PTZ) camera. The PTZ camera may change a focus in response to a movement of an object to acquire a centralized image of the object as well as a high resolution image.

The user may receive a broadcast service associated with an image acquired by the fixed camera or the moving camera using the above-discussed system. However, it may be difficult to provide an image of a desired portion to the user even though a broadcaster provides a real time image or an edited image of the image acquired by the fixed camera or the moving camera.

Concisely, although the centralized-captured image of the object is collected from the moving camera, the collected image may be provided as a predetermined configuration of a frame in a typical broadcast service and thus, the user may not receive an image captured at a desired viewpoint. Additionally, a user may need to operate the moving camera in person to acquire an image for an object only, which may lead to an increase in costs and effort. Also, the number of objects may be restricted to appropriately provide the service.

Accordingly, there is a desire for a service of providing an image of an object tracked through an automated tracking-based interactive camera control and a service of providing an image captured at a desired viewpoint of a user.

### SUMMARY

An aspect provides an object image providing method performed by tracking an object of interest using fixed cameras in real time to acquire a zoomed-in image of the object of interest with a high resolution using a plurality of pan-tilt-zoom (PTZ) cameras based on the tracked position of the object of interest.

Another aspect also provides an object image providing method of selectively receiving images acquired at various angles by focusing on a desired object of a user to provide an image of the desired object through a broadcast service.

According to an aspect, there is provided a method of providing an object image, the method including collecting a global image including an object of interest located in a predetermined space using fixed cameras provided in the predetermined space, analyzing the object of interest in the collected global image and determining coordinates of the object of interest for each of the fixed cameras, converting the determined coordinates into coordinates of a tracking camera photographing a predetermined area of the predetermined space, and collecting an additional image including the object of interest at the converted coordinates using the tracking camera.

The analyzing may include analyzing the object of interest in the global image collected from each of the fixed cameras based on an object tracking scheme.

The object tracking scheme may be to track a position of the object of interest in the global image using a color histogram of the object of interest included in the global image.

The analyzing may include determining the coordinates of the object of interest based on a common coordinate system that is applicable to the fixed cameras in consideration of a relative location relationship between the fixed cameras.

The converting may include converting the coordinates of the object of interest into the coordinates of the tracking camera based on a spatial location relationship between the tracking camera and each of the fixed cameras.

The collecting of the additional image may include collecting the additional image by tracking the object of interest at the coordinates in the predetermined space using the tracking camera controlled to photograph the predetermined area including the converted coordinates.

A photographing angle and a photographing range of the tracking camera may be differently set based on a position of the tracking camera in the predetermined space.

The additional image may be a centralized-photographed image acquired using a pan-tilt-zoom function of the tracking camera in response to a motion of the object of interest included in the global image.

The method may further include mapping the global image and the additional image based on an interactive relationship between the tracking camera and each of the fixed cameras, and displaying, when a user selects the global image displayed on a display, the additional image mapped to the selected global image on the display.

According to another aspect, there is also provided a method of providing an object image, the method including collecting a global image and an additional image of a predetermined space using a fixed camera and a tracking camera, displaying broadcast contents including the global image and the additional image on the display, receiving an input of an object of interest selected by a user from the broadcast contents displayed on the display, and analyzing the object of interest selected from the broadcast contents and displaying the additional image mapped to the global image configuring the broadcast contents on the display.

The collecting may include collecting the global image including the object of interest located in the predetermined space using a plurality of fixed cameras provided in the predetermined space, analyzing the object of interest in the collected global image and determining coordinates of the object of interest for each of the fixed cameras, converting the determined coordinates into coordinates of the tracking camera photographing a predetermined area of the predetermined space, and collecting the additional image including the object of interest at the converted coordinates using the tracking camera.

The analyzing may include tracking a position of the object of interest in the global image based on an object tracking scheme performed using a color histogram of the object of interest in the global image.

The analyzing may include determining the coordinates of the object of interest based on a common coordinate system that is applicable to the fixed cameras in consideration of a relative location relationship between the fixed cameras.

The converting may include converting the coordinates of the object of interest into the coordinates of the tracking camera based on a spatial location relationship between the tracking camera and each of the fixed cameras.

The collecting of the additional image may include collecting the additional image acquired by tracking the object of interest at the coordinates in the predetermined space using the tracking camera controlled to photograph the predetermined area including the converted coordinates.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an overall system for performing an object image providing method according to an example embodiment;

FIG. 2 is a diagram illustrating an operation of determining coordinates of an object of interest in a global image collected using a fixed camera according to an example embodiment;

FIG. 3 is a diagram illustrating an operation of collecting an additional image including an object of interest using a tracking camera according to an example embodiment;

FIG. 4 is a flowchart illustrating an object tracking scheme performed by tracking an object of interest from a global image collected using a fixed camera according to an example embodiment; and

FIG. 5 is a flowchart illustrating an object image providing method according to an example embodiment.

### DETAILED DESCRIPTION

Hereinafter, example embodiments will be described in detail with reference to the accompanying drawings.

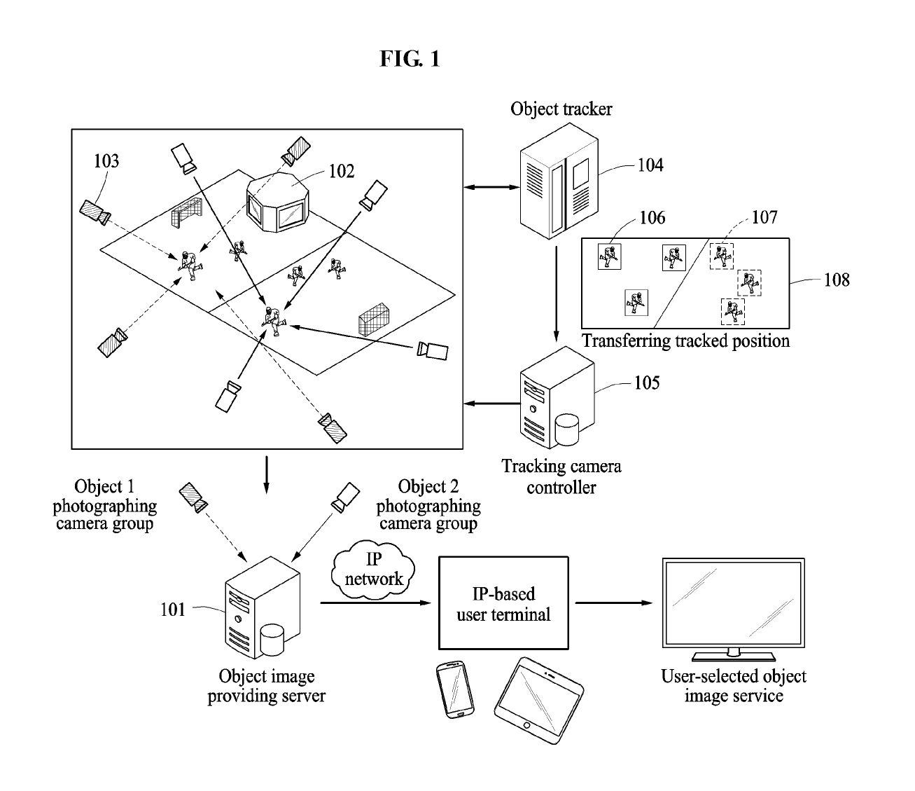

FIG. 1 is a diagram illustrating an overall system for performing an object image providing method according to an example embodiment.

Referring to FIG. 1, an object image providing server 101 for providing an object image may provide an image of an object of interest in contents in response to a selection of a user in addition to providing an image service dependent on contents acquired by a broadcasting producer.

To this end, the object image providing server 101 may collect a global image 108 including an object of interest located in a predetermined space from fixed cameras 102 positioned in the predetermined space. Here, the predetermined space may include, for example, a space to be monitored and a space available for users for various purposes. The space available for users for various purposes may be a stadium, a security zone, a parking lot, and the like, for example.

The fixed camera 102 may be positioned on a ceiling of the predetermined space to photograph the space overall based on a full frame at an angle of view set for the corresponding fixed camera 102. Also, the fixed camera 102 may collect the global image 108 acquired in a top-to-bottom view based on an angle and a position set in the predetermined space.

In the predetermined space, a plurality of objects may present in a stationary state or a moving state. Among the objects, objects in the moving state may each be defined as an object of interest. The object of interest may indicate an object moving in the predetermined space such as a player participating in a game, an observer, a judge, and the like, for example. The object image providing server 101 may analyze the global image 108 photographed by the fixed camera 102 and track an object of interest associated with an object appearing in the global image 108.

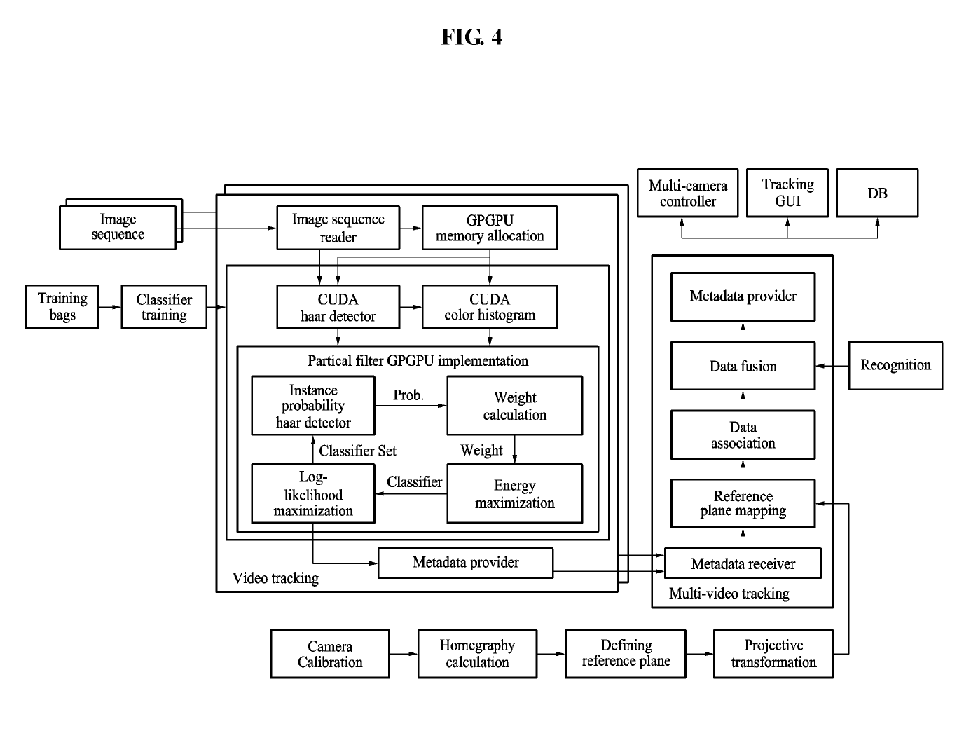

The object image providing server 101 may analyze an object of interest 106 and an object of interest 107 included in the global image 108 collected using the fixed cameras 102 and determine coordinates of the object of interest 106 and coordinates of the object of interest 107. Here, the object image providing server 101 may employ an object tracking scheme to analyze the object of interest 106 and the object of interest 107 included in the global image 108 collected from each of the fixed camera 102 and determine the coordinates of the object of interest 106 and the coordinates of the object of interest 107 in association with the fixed cameras 102. The object tracking scheme may be, for example, a scheme of tracking the positions of the objects of interest 106 and 107 in the global image 108 by applying a color histogram associated with the objects of interest 106 and 107 in the global image 108, and related descriptions will be provided in detail with reference to FIG. 4.

The object image providing server 101 may operate in conjunction with tracking cameras 103 at various positions in the predetermined space based on the determined coordinates of the object of interest 106 and the determined coordinates of the object of interest 107 to collect additional images capturing the object of interest 106 and the object of interest 107 at various angles. Here, the tracking camera 103 may be, for example, pan-tilt-zoom (PTZ) cameras.

The object image providing server 101 may convert each of the determined coordinates into coordinates of the tracking camera 103 photographing a predetermined area in the predetermined space. Also, to operate in conjunction with the tracking camera 103 based on the coordinates of the objects of interest 106 and 107 associated with the fixed cameras 102, the object image providing server 101 may convert each of the determined coordinates into the coordinates of the tracking camera 103 photographing the predetermined area in the predetermined space.

Specifically, the tracking camera 103 may be disposed perpendicular to a ground of the predetermined space to collect an image capturing the objects of interest 106 and 107 in a direction the same as a gaze direction of an individual while the fixed camera 102 collects an image in the top-to-bottom view. Since the fixed camera 102 and the tracking camera 103 collect images in different directions, different coordinates may be obtained by the fixed camera 102 and the tracking camera 103 in a process of tracking the positions of the objects of interest 106 and 107.

Concisely, positions of the objects of interest 106 and 107 acquired by the fixed cameras 102 may differ from positions of the objects of interest 106 and 107 that may be acquired by the tracking camera 103. To unify coordinates of the fixed camera 102 and the tracking camera 103, the object image providing server 101 may determine coordinates of the objects of interest 106 and 107 based on a common coordinate system applicable to the fixed cameras 102 in consideration of a relative location relationship between the fixed cameras 102, and convert the determined coordinates into coordinates of the tracking camera 103 in consideration of a relative location relationship between the fixed camera 102 and the tracking camera 103. Through this, the fixed camera 102 and the tracking camera 103 may be allowed to operate in conjunction with each other. Here, “converting the coordinates of the objects of interest 106 and 107 into the coordinates of the tracking camera 103” may indicate, for example, “converting the coordinates of the objects of interest 106 and 107 into coordinates of the common coordinate system shared between the fixed camera 102 and the tracking camera 103.

The object image providing server 101 may control a position of the tracking camera 103 such that the tracking camera 103 indicates corresponding coordinates based on the coordinates shared between the fixed camera 102 and the tracking camera 103. In this example, the object image providing server 101 may control the tracking cameras 103 positioned adjacent to the converted coordinates to acquire additional images of the objects of interest 106 and 107. The object image providing server 101 may classify the additional images for each the objects of interest 106 and 107 and store the additional images in a memory. In an example, the object image providing server 101 may classify additional images of a first object of interest, for example, the object of interest 106 and additional images of a second object of interest, for example, the object of interest 107 and store the additional images in the memory.

In an example of FIG. 1, the object image providing server 101 may determine the coordinates of the object of interest 106 and the coordinates of the object of interest 107 associated with the fixed camera 102 using an object tracker 104. Also, the object tracker 104 may convert each of the determined coordinates into the coordinates of the tracking camera 103 and then, transfer the converted coordinates to a tracking camera controller 105. The tracking camera controller 105 may control positions of the tracking cameras 103 positioned in the predetermined space based on the converted coordinates and collect the additional image from each of the tracking cameras 103 at the controlled positions.

Although FIG. 1 illustrates that the object image providing server 101 acquires information on the objects of interest 106 and 107 using the object tracker 104 and the tracking camera controller 105 separate from the object image providing server 101, the object tracker 104 and the tracking camera controller 105 may also be included in the object image providing server 101 and operate therein.

The object image providing server 101 may map the additional image based on the global image 108 by lapse of time. Also, the object image providing server 101 may provide broadcast contents to an Internet protocol (IP)-based user terminal through an IP network. Here, the broadcast contents may include the global image 108 and the additional image acquired using the fixed camera 102 and the tracking camera 103. Also, the broadcast contents may be, for example, an image through which the broadcast contents are provided in real time and an image edited in advance.

The broadcast contents may be an image edited by a broadcasting producer based on the global image 108 and the additional image and an image on a broadcast screen obtained by combining multiple viewpoint images using the fixed cameras and moving cameras, for example, the tracking cameras 103. In this example, the broadcast contents may be in a state in which the edited image is mapped to the additional image corresponding to the objects of interest 106 and 107 included in a scene of the edited image by lapse of time. Also, a user may select the objects of interest 106 and 107 from images of the broadcast contents provided by the object image providing server 101. Through this, the user may receive images acquired by capturing the selected objects of interest 106 and 107 at various angles among images captured by focusing on the objects of interest 106 and 107.

The user may additionally select a desired object in the broadcast contents in lieu of broadcast contents provided through a general broadcast service so as to view an additional image acquired by capturing the desired object using the tracking camera 103. Also, in a process of collecting the additional image, the additional image may be automatically acquired by the tracking camera 103 based on the coordinates of the objects of interest 106 and 107 captured by the fixed camera 102. Through this, in a process of acquiring images, the image may be acquired with less effort of the producer without restrictions on the number of cameras and the number of objects of interest.

Accordingly, an object image providing server may propose an automation technique enabling a user to selectively view an additional image for each object of interest by applying automatic control technology for object tracking and a PTZ camera to broadcast contents provided by a broadcast contents producer.

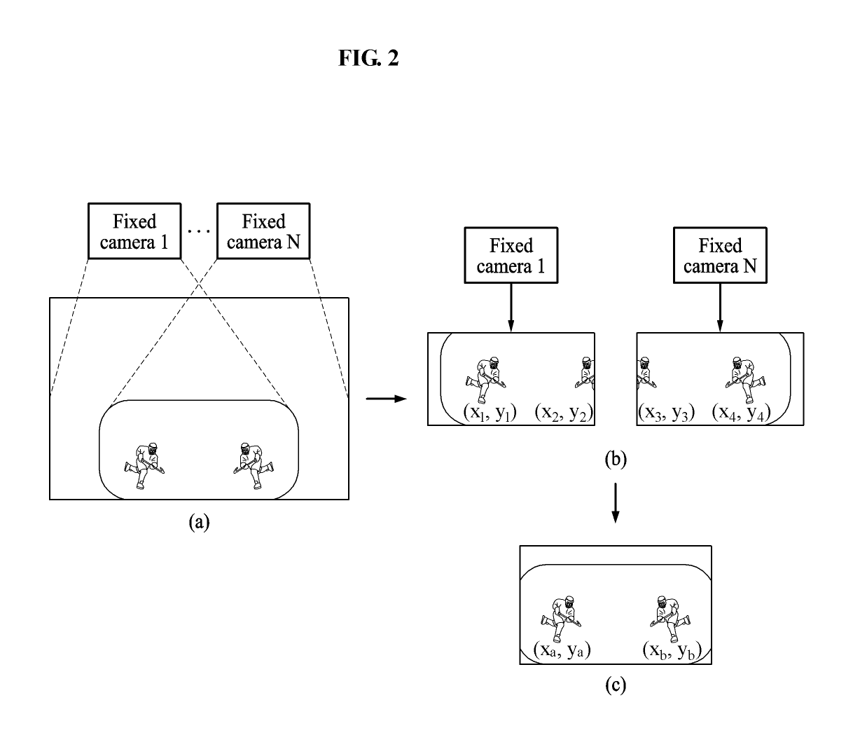

FIG. 2 is a diagram illustrating an operation of determining coordinates of an object of interest in a global image collected using a fixed camera according to an example embodiment.

Referring to FIG. 2, an object image providing server may convert coordinates of an object of interest into coordinates associated with tracking cameras photographing a predetermined area of a predetermined space. Also, to interconnect fixed cameras with the tracking cameras based on the coordinates of the object of interest, the object image providing server may convert the coordinates of the object of interest into the coordinates of the tracking cameras photographing the predetermined area of the predetermined space. For example, the object image providing server may convert the coordinates of the object of interest into coordinates of a common coordinate system shared between the fixed cameras and the tracking cameras.

In a part (a) of FIG. 2, the object image providing server may collect a global image of an object of interest in a predetermined space in real time using a plurality of fixed cameras positioned in the predetermined space. Each of the fixed cameras may collect a global image having a different range based on an angle and a position in the predetermined space. The global image collected from each of the fixed cameras may include an overlapping area in the predetermined space.

For example, as illustrated in a part (b) of FIG. 2, a global image 1 collected from a fixed camera 1 and a global image 2 collected from a fixed camera 2 may include an overlapping portion capturing the same area. Also, coordinates of the object of interest in the global image 1 may differ from coordinates of the object of interest in the global image 2. Concisely, although the fixed camera 1 and the fixed camera 2 acquire global images of the same space, coordinates of each of the global images may differ due to different angles and different positions of the fixed camera 1 and the fixed camera 2.

In a part (c) of FIG. 2, the object image providing server may apply an object tracking scheme to the global image 1 and the global image 2 and convert positions of the object of interest into a common coordinate system. Through this, the object image providing server may generate a coordinate system commonly used in both fixed camera and tracking camera. Here, the object tracking scheme may indicate a scheme of tracking a position of an object of interest in a global image using a color histogram of the object of interest included in the global image. For example, in the object tracking scheme, a position of an object may be tracked based on at least one of a mean shift, a Kalman filter, and a particle Filter. In this example, a mean shift-based object tracking scheme may be a scheme of detecting a peak or a centroid of data distribution and tracking a position of an object of interest in a global image. A Kalman filter-based object tracking scheme may be a scheme of tracking a position of an object optimal for detecting a state variable using a stochastic model and a measurement value in a global image. A particle filter-based object tracking scheme may be a scheme of tracking a position of an object to be tracked by extracting information on the object using a color histogram.

The object image providing server may generate one integrated global image that covers a wide area based on global images acquired by a plurality of global cameras and a unified coordinate system. Also, the object image providing server may detect an object of interest based on global images acquired using the fixed cameras and may track the object of interest.

The object image providing server may transmit coordinates tracked using the object tracking scheme to the tracking cameras positioned in the predetermined space. Also, the object image providing server may control positions of the tracking cameras such that the tracking cameras indicate the transmitted coordinates. The object image providing server may employ technology for interconnecting a fixed camera with a tracking camera and controlling the tracking camera to automatically acquire an additional image acquired by zooming-in an object of interest at a high resolution using the tracking camera.

The object image providing server may control the tracking cameras allocated for each object of interest based on positions of objects of interest each tracked on the unified coordinate system and acquire additional images acquired by capturing the objects of interest at various angles.

Also, the acquired additional images may be classified for each of the object of interest and stored in a memory of the object image providing server. The object image providing server may sequentially store the additional images by lapse of time.

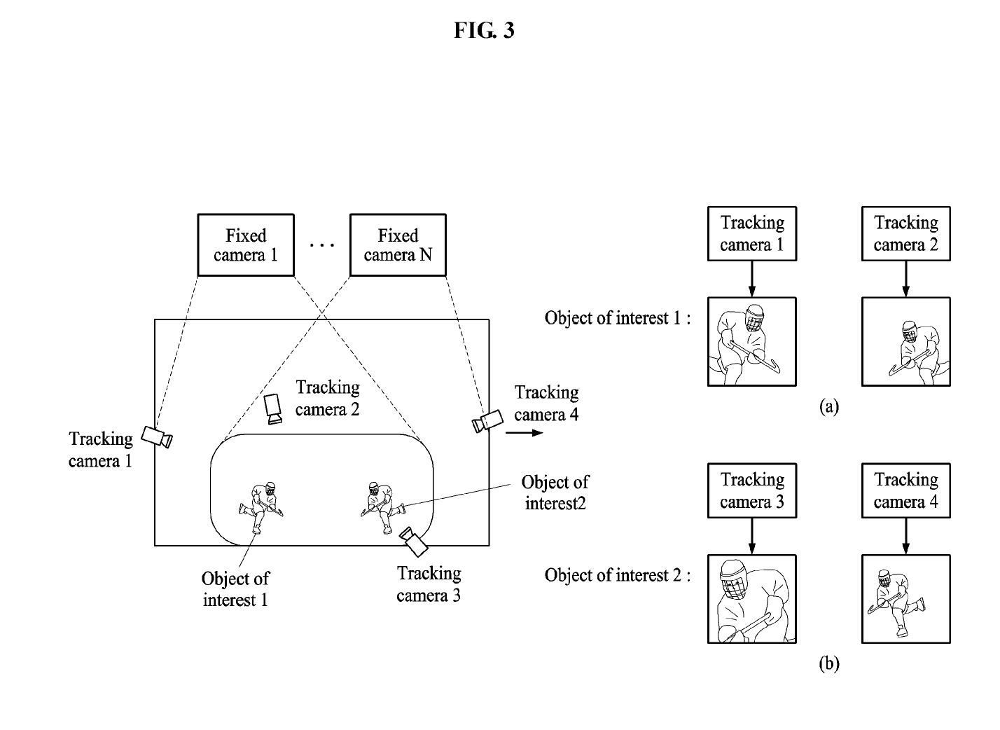

FIG. 3 is a diagram illustrating an operation of collecting an additional image including an object of interest using a tracking camera according to an example embodiment.

Referring to FIG. 3, an object image providing server may collect a global image and an additional image of an object of interest located in a predetermined space using a fixed camera and a tracking camera.

Specifically, the object image providing server may convert a position of the object of interest into a common coordinate system based on an object tracking scheme and generate a coordinate system commonly used in both fixed camera and tracking camera. Also, the object image providing server may determine the position, for example, coordinates of the object of interest in the predetermined space based on the generated coordinate system.

As illustrated in parts (a) and (b) of FIG. 3, the object image providing server may acquire centralized-photographed images for each of an object of interest 1 and an object of interest 2 captured by different tracking cameras mapped to the object of interest 1 and the object of interest 2. Thus, when a plurality of tracking cameras photographs one object of interest to acquire additional images, a range by which the object of interest is captured may vary based on a position of each of the tracking cameras.

The fixed camera may share the common coordinate system with the tracking camera positioned in the predetermined space using a homography. In response to receiving the coordinates of the object of interest based on the common coordinate system shared between the fixed camera and the tracking camera, the tracking camera may be interactively controlled to be positioned to indicate the received coordinates. Using the interactively controlled tracking camera, an image of the object of interest tracked based on the coordinates may be collected. Accordingly, the tracking camera may automatically perform centralized-photographing on the object of interest tracked by the fixed camera in real time.

According to example embodiments, an object image providing method may be performed by tracking a plurality of objects of interest using a plurality of fixed cameras, transferring coordinates of a corresponding object of interest to a group of tracking cameras designated for each of the objects of interest, tracking the object of interest using the tracking cameras through an interactive control between the fixed cameras and the tracking cameras, and acquiring additional images of the object of interest with increased accuracy. In the object image providing method, additional images may be classified and stored for each of the objects of interest such that the additional images are provided as an additional service in association with broadcast contents in response to a request from a user.

Also, using the object image providing method, the user may select a desired image from images photographed by each of the tracking cameras at various angles and may view the selected image in response to a change in a posture of the object of interest and a direction in which the object of interest faces in real time.

FIG. 4 is a flowchart illustrating an object tracking scheme performed by tracking an object of interest from a global image collected using a fixed camera according to an example embodiment.

Referring to FIG. 4, an object image providing server may employ a particle filter-based object tracking scheme among object tracking schemes based on a mean shift, a Kalman filter, and the particle filter of FIG. 3 as an example although an object tracking scheme is not limited to the example.

The particle filter-based object tracking scheme may be performed by the object image providing server as described with reference to FIG. 4. The object image providing server may detect an object included in an image using a Haar detector and extract information on an object of interest to be tracked in the image using a color histogram. Based on the extracted information, the object image providing server may generate candidates of a location value of the object of interest. The object image providing server may spread numerous particles to predetermined positions with respect to the generated candidates and update a probability value for each of the candidates based on a global image.

The calculated value for each of the particles may be used for a weight calculation. The object image providing server may obtain classifiers for determining whether a corresponding candidate is the object of interest to be tracked for each of the candidates so as to maximally satisfy an energy condition for determining a tracking location. Using the obtained classifiers, the object image providing server may repetitively perform the aforementioned process of obtaining the classifiers through energy optimization, the weight calculation, and the probability value calculation with respect to the particles until the position of the object of interest converges onto a predetermined value. In this example, initial classifiers may be previously calculated through a training process or initialized to be predetermined classifiers.

Based on a tracking result of the particle filter-based object tracking scheme, an object image providing server may generate a single integrated global image using global images of a plurality of fixed cameras and perform a conversion into a unified coordinate system.

Identification information associated with the tracked object of interest may be designated as priori information, for example, in a process of generating the broadcast contents and in a process of recognizing a face of the object of interest or recognizing a player based on a uniform number recognition scheme. In the unified coordinate system, tracked location information of the object of interest may be transferred to a plurality of tracking cameras for an interactive control, and may also be transferred to a camera display screen to inform of a tracking status. The tracked location information of the object of interest may be stored and managed in a database (DB) in the object image providing server for a future reference.

Accordingly, the object image providing server may provide an object image service in association with broadcast contents. Here, the image object service may be used to interactively control object tracking-based multiple cameras, for example, a fixed camera and a tracking camera and provide additional images acquired at various angles for each object of interest.

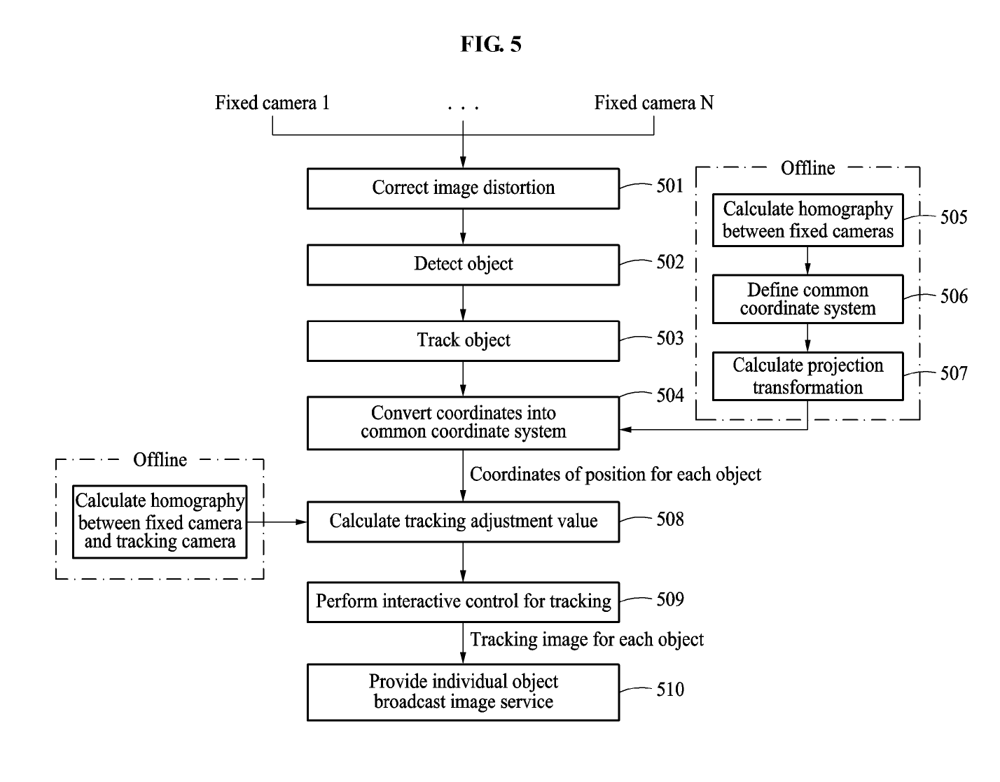

FIG. 5 is a flowchart illustrating an object image providing method according to an example embodiment.

An object image providing server may interconnect a fixed camera and a tracking camera and control the fixed camera and the tracking camera to perform an operation for acquiring additional images acquired by capturing an object of interest at various angles. To this end, the object image providing server may perform the following operations.

In operation 501, the object image providing server may correct distortions of global images collected from a plurality of fixed cameras. Specifically, the object image providing server may collect global images including an object of interest located in a predetermined space from the plurality of fixed cameras positioned in the predetermined space. For example, the object image providing server may collect global images including an object of interest located in a predetermined space from fixed cameras 1 through N. Also, the object image providing server may correct distortions in the collected global images.

In operation 502, the object image providing server may detect the object of interest included in the global images collected from the plurality of fixed cameras. The object image providing server may detect the object of interest included in the global images based on an object tracking scheme. For example, when the global images acquired by the plurality of fixed cameras are input, the object image providing server may calculate positions of the object of interest in the input global images based on a mean shift, a Kalman filter, or a particle Filter.

In operation 503, the object image providing server may track a position of the object of interest located in a frame for each of the global images based on coordinates of the object of interest calculated based on the object tracking scheme.

In operation 504, the object image providing server may convert the coordinate of the object of interest associated with the fixed camera into a common coordinate system, for example, a unified coordinate system that is also commonly used by tracking cameras for an interactive control between the fixed cameras and the tracking cameras.

In operation 505, the object image providing server may calculate a homography based on a relative location relationship between the fixed cameras. In operation 506, the object image providing server may set a definition for the common coordinate system. Here, “setting of the definition for the common coordination system” may be understood as, for example, “defining coordinates of a tracking camera indicated in association with the object of interest detected from the global images”. Also, the relative location relationship may indicate a location relationship between the fixed cameras positioned in the predetermined space. In operation 507, the object image providing server may convert the determined coordinates of the object of interest into the coordinates of the tracking camera in consideration of a spatial location relationship between the tracking camera and each of the fixed cameras. In operation 507, the object image providing server may calculate a projection transformation based on a spatial location relationship between the fixed camera and the tracking camera to convert the coordinates of the object of interest into the coordinates of the tracking camera.

The object image providing server may convert the coordinates of the object of interest associated with the fixed cameras into the unified coordinate system in operation 504 based on operations 505 through 507 performed in an offline state. Thus, the object image providing server may convert positions of the object of interest obtained using a plurality of fixed cameras into coordinates of the common coordinate system.

In operation 508, the object image providing server may calculate a tracking adjustment value of the tracking camera using the coordinates of the tracking camera for tracking the object of interest based on the unified coordinate system. For example, the object image providing server may calculate the tracking adjustment value of the tracking camera such that the tracking camera indicates corresponding coordinates based on the coordinates of the object of interest. In this example, the object image providing server may calculate a homography based on the spatial location relationship between the fixed camera and the tracking camera through offline and calculate the tracking adjustment value of the tracking camera.

Here, the spatial location relationship may indicate a location relationship between a space of the fixed camera and a space of the tracking camera in the predetermined space. For example, the fixed camera may be installed on a ceiling of the predetermined space and the tracking camera may be installed on a ground of the predetermined space. Thus, the object image providing server may calculate the homography in consideration of the spatial location relationship between the ceiling and the ground.

The object image providing server may employ a method such as a homography to define a relationship between the fixed camera and the tracking camera in order to convert the coordinates of the object of interest in the fixed camera into the coordinates of the tracking camera.

In operation 509, the object image providing server may interactively control the tracking camera and the fixed camera based on the calculated tracking adjustment value of the tracking camera.

In operation 510, an additional image of the object of interest captured by the tracking camera may be automatically stored in a memory in the object image providing server through a process of performing operations 504 through 509. Also, the global images and the additional image of the object of interest generated through the foregoing process may be stored with broadcast contents so as to be additionally provided as an image of the object of interest in a time zone the same as that of typical broadcasting contents when a user selects a desired object in a user terminal.

According to an aspect, it is possible to provide an object image providing method performed by acquiring a zoomed-in image of an object of interest with a high resolution using a plurality of PTZ cameras based on a position of the object of interest tracked by a plurality of fixed cameras to enable a user to selectively receive images captured by focusing on the object of interest of the user at various angles.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

A number of example embodiments have been described above. Nevertheless, it should be understood that various modifications may be made to these example embodiments. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A method of providing an object image, the method comprising:
collecting a global image including an object of interest located in a predetermined space using fixed cameras provided in the predetermined space;
analyzing the object of interest in the collected global image and determining coordinates of the object of interest for each of the fixed cameras;
converting the determined coordinates into coordinates of a tracking camera photographing a predetermined area of the predetermined space; and
collecting an additional image including the object of interest at the converted coordinates using the tracking camera.

2. The method of claim 1, wherein the analyzing includes analyzing the object of interest in the global image collected from each of the fixed cameras based on an object tracking scheme.

3. The method of claim 2, wherein the object tracking scheme is to track a position of the object of interest in the global image using a color histogram of the object of interest included in the global image.

4. The method of claim 1, wherein the analyzing includes determining the coordinates of the object of interest based on a common coordinate system that is applicable to the fixed cameras in consideration of a relative location relationship between the fixed cameras.

5. The method of claim 1, wherein the converting includes converting the coordinates of the object of interest into the coordinates of the tracking camera based on a spatial location relationship between the tracking camera and each of the fixed cameras.

6. The method of claim 1, wherein the collecting of the additional image includes collecting the additional image by tracking the object of interest at the coordinates in the predetermined space using the tracking camera controlled to photograph the predetermined area including the converted coordinates.

7. The method of claim 1, wherein a photographing angle and a photographing range of the tracking camera are differently set based on a position of the tracking camera in the predetermined space.

8. The method of claim 1, wherein the additional image is a centralized-photographed image acquired using a pan-tilt-zoom function of the tracking camera in response to a motion of the object of interest included in the global image.

9. The method of claim 1, further comprising:
mapping the global image and the additional image based on an interactive relationship between the tracking camera and each of the fixed cameras; and
displaying, when a user selects the global image displayed on a display, the additional image mapped to the selected global image on the display.

10. A method of providing an object image, the method comprising:
collecting a global image and an additional image of a predetermined space using a fixed camera and a tracking camera;
displaying broadcast contents including the global image and the additional image on the display;
receiving an input of an object of interest selected by a user from the broadcast contents displayed on the display; and
analyzing the object of interest selected from the broadcast contents and displaying the additional image mapped to the global image configuring the broadcast contents on the display.

11. The method of claim 10, wherein the collecting includes:
collecting the global image including the object of interest located in the predetermined space using a plurality of fixed cameras provided in the predetermined space;
analyzing the object of interest in the collected global image and determining coordinates of the object of interest for each of the fixed cameras;
converting the determined coordinates into coordinates of the tracking camera photographing a predetermined area of the predetermined space; and
collecting the additional image including the object of interest at the converted coordinates using the tracking camera.

12. The method of claim 11, wherein the analyzing includes tracking a position of the object of interest in the global image based on an object tracking scheme performed using a color histogram of the object of interest in the global image.

13. The method of claim 11, wherein the analyzing includes determining the coordinates of the object of interest based on a common coordinate system that is applicable to the fixed cameras in consideration of a relative location relationship between the fixed cameras.

14. The method of claim 11, wherein the converting includes converting the coordinates of the object of interest into the coordinates of the tracking camera based on a spatial location relationship between the tracking camera and each of the fixed cameras.

15. The method of claim 11, wherein the collecting of the additional image includes collecting the additional image acquired by tracking the object of interest at the coordinates in the predetermined space using the tracking camera controlled to photograph the predetermined area including the converted coordinates.
